(19) United States
(12) Patent Application Publication
(10) Pub. No.: US 2007/0003033 A1
(43) Pub. Date: Jan. 4, 2007

(54) Method and apparatus for deriving primary and secondary billing schemes

(75) Inventors: Peter John Edwards, Bernex (CH); Richard J. Smolucha, Naples, FL (US)

Correspondence Address: HEWLETT-PACKARD COMPANY;Intellectual Property Administration, P.O. Box 272400, Fort Collins, CO, 80527-2400, US

(73) Assignee: Hewlett - Packard Development Company, L.P.

(21) Appl. No.: 11/165,836

(22) Filed: Jun. 24, 2005

(51) Int. Cl. H04M 15/00

(52) U.S. Cl. 379/114.01

(57) ABSTRACT

A method of deriving a primary and secondary billing scheme for a plurality of services each having a respective service consumption cost comprises, at a billing entity, receiving service consumption data. The billing entity applies each of a primary and secondary service consumption pricing plan to the service consumption data to derive respective primary and secondary billing schemes.

### FIELD OF THE INVENTION

The invention relates to a method and apparatus for deriving primary and secondary billing schemes.

### BACKGROUND OF THE INVENTION

In consumption based billing, services are charged based on the level of their consumption or usage. For example where a service user uses multiple services, each may be billed at a cost per usage unit. However it is desirable for the service user to obtain efficiencies in service usage where possible, for example in order to ensure that appropriate budgets are met. This requirement can be either at the individual level or at a cost centre or corporate level, for example under the control of a chief information officer (CIO).

### BRIEF SUMMARY OF THE INVENTION

A method of deriving a primary and secondary billing scheme for a plurality of services each having a respective service consumption cost comprises, at a billing entity, receiving service consumption data. The billing entity applies each of a primary and secondary service consumption pricing plan to the service consumption data to derive respective primary and secondary billing schemes.

### BRIEF DESCRIPTION OF THE DRAWINGS

Embodiments of the invention will now be described, by way of example only, with reference to the drawings, of which:

FIG. 1 is a schematic block diagram showing derivation of a primary billing scheme;

FIG. 2 is a block diagram illustrating a mapping according to the method described herein;

FIG. 3 is a flow diagram showing the steps performed by a service provider in implementing the method described herein;

FIG. 4 shows application of a secondary pricing plan; and

FIG. 5 is a block diagram illustrating a computer apparatus for implementing the method described herein.

### DETAILED DESCRIPTION OF THE INVENTION

There will now be described by way of example the best mode contemplated by the inventors for carrying out the invention. In the following description numerous specific details are set forth in order to provide a thorough understanding of the present invention. It will be apparent however, to one skilled in the art, that the present invention may be practiced without limitation to these specific details. In other instances, well known methods and structures have not been described in detail so as not to unnecessarily obscure the present invention.

In overview a service provider 100 provides a billing service to a service user or customer 102, for example via the CIO or IT department 104 of the service user. The service user has a plurality of cost centres CC1-CC3 which may be, for example, different departments within the service user company which are treated as autonomous billing centres shown here as 106, 108, 110. For each cost centre the cost centre members, or users U1-U4 to whose service consumption costs are allocated, shown here at 112, 114, 116, 118 for cost centre CC1 are monitored for example by a third party entity 80 such as a telephone company which provides service consumption data to a billing entity 120 such as a billing processor. The billing entity further receives a service consumption pricing plan 114. In the case of a primary pricing plan, a primary service billing scheme is derived based on the agreed consumption cost. For example where a user U1 uses services S1, S2, S3, S4 comprising a landline telephone, mobile telephone, printer and broadband network access respectively, the primary pricing plan generates a bill dependent on the usage of each service by the user U1 for example on the basis of a cost per unit of usage multiplied by the number of units used.

Separately, a secondary pricing plan applied at the billing entity is a variation of the first pricing plan to generate a secondary service billing scheme. Both billing schemes are transmitted to the CIO or IT department 104 at the service user 102.

The provision of two plans allows a differentiated allocation of costs between cost centres or services to take place. For example it may be desirable to reward or encourage use of certain services (for example cheaper services such as landline telephone and broadband network access) whilst increasing the costs attached to less preferred services (for example mobile telephone or printer) which in turn may discourage users from over using expensive services.

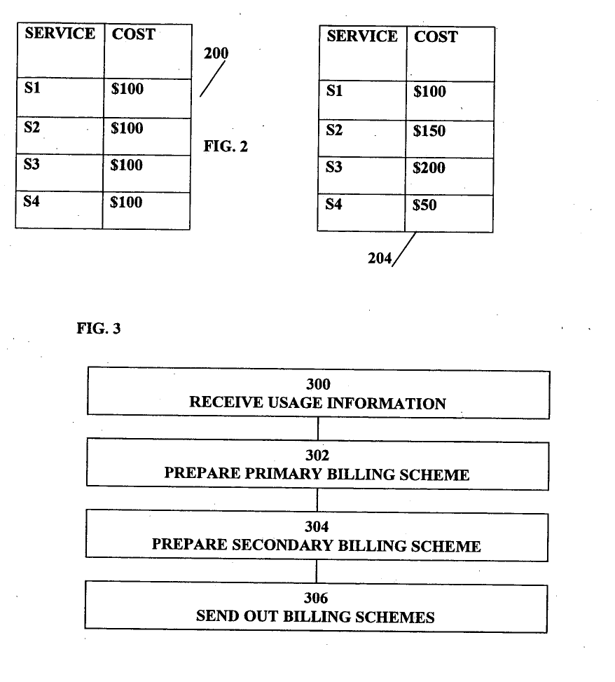

For example, as shown in FIG. 2, where each of the services S1, S2, S3, S4 has an agreed cost of $100 based on consumption according to the primary pricing plan following the secondary pricing plan a cost of $100 for services S1 and $50 for S4 (as examples, a factor of 1:1 and 1:2 for preferred services) but respective costs of $150 and $200 for services 2 and 3 (an uplift factor of 1.5:1 and 2:1 for each of these less preferred services, again as examples) is derived.

It will be seen that the cost allocation scheme can be broken down yet further for example by cost centre, and that alternative mappings or variations can be adopted. As a result, the service user can be billed according to the primary cost structure but can be offered the secondary cost structure by the service provider for use in an internal cost allocation. As a result the service provider can provide rebilling on the behalf of the service user using existing consumer based billing flows allowing an inexpensive and high quality service to be provided. The services can be, for example, computer related such as computer, network or peripheral usage, or telephony service such as mobile or land line telephony.

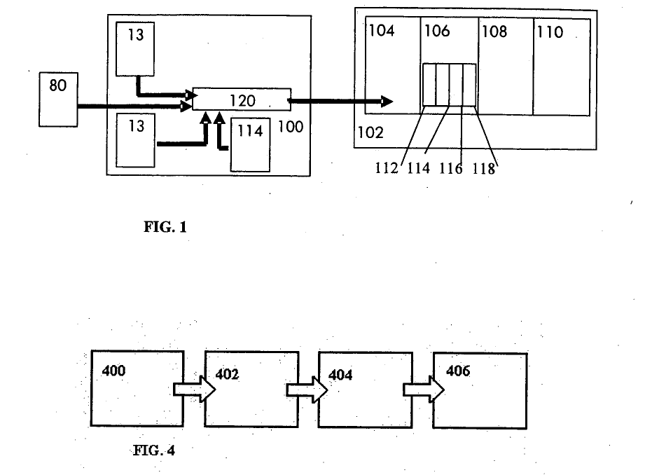

Referring now to FIG. 3 in conjunction with FIG. 1, steps carried out at a service provider can be understood in more detail. At step 300 a service provider receives service usage information for example using existing consumption based billing flows and information. This may be from a third party 80 such as a telecoms provider or from an entity 130 internal to the service provider such as a call centre which provides a service to the service user to be billed back to the service user. In step 302, therefore, the primary billing scheme is derived according to the primary pricing plan. To achieve this it is merely necessary that the service is being tracked and billed should be clearly defined according to the consumption based billing cost plan identifying the service unit being tracked and billed and the unit price for these service units. For example, in a desk-top management service, the “unit” might be “number of desk-top computers under management”, and the unit cost might be “$10 per month”. Collection and quality checking of the service consumption can be achieved in any appropriate manner. For example in the case of desktop management this can be done -using a network tracing tool of any appropriate type. It will be recognised that any appropriate service such as a telephone service, computer usage service, network usage service or peripheral usage service such as printer or data storage can be monitored as appropriate, using any appropriate application set which is capable of processing, assembling, storing, rating and reporting of appropriate data.

It will further be seen that allocation of costs to cost centres can be carried out additionally using service user hierarchy data 132. The hierarchy can show organisational information such as which users are members of which cost centre as a result of which individual user costs can be agglomerated and billed to the respective cost centres. The customer hierarchy information may of course require dynamic update in response to variation in the customer hierarchy.

In step 304 a secondary billing scheme is derived according to a secondary pricing plan determined for or on behalf of the service user. The secondary pricing plan allows the service user to re-price services for onward, internal billing. This can be done according to various criteria. For example users can be incited to use cheaper services in the place of expensive ones, for example encouraging the use of (cheap) fixed-line telephony instead of (more expensive) mobile telephony by making the fixed-line telephony free at the point of use or priced at cost and adding a premium for mobile telephony. An example is to allow acceleration of the deployment of new tools and obsolescence of old ones by respectively decreasing and increasing their prices at the point of use during the roll out period. Yet a further alternative is to allow the service user intermediary administering the pricing plan (such as the IT department or CIO) to cover their own costs through an appropriate uplift in the price charged on, differentiating by cost centre. In many instances the pricing plan comprises a modified pricing plan in the form of a straightforward table giving a differential service pricing structure compared to the primary pricing plan which can be easily set up and managed by the customer. It will be seen that, in practice, the secondary billing process can be implemented by re-running the application used to rate and report the services to prepare the primary bill according to the service-user defined requirements. Alternatively, however the service provider, based on core criteria provided by the service user or on independently derived criteria, may suggest or impose a secondary pricing plan, for example as a transformation of the primary pricing plan

In step 306 the service provider sends out the secondary bill to the service user. It will be seen that, in practice, this can be sent out with the primary bill. As a result the user will receive the actual bill to be paid to the service provider in the form of the primary bill. In addition to this, however, the service user will also receive the internal re-billing in the form of the secondary bill to be passed on to the internal users or cost centres within the service user organisation.

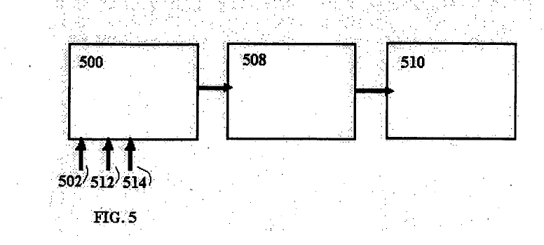

Referring to FIG. 4 it will be seen that any appropriate approach can be implemented to provide the service cost variation in the secondary pricing plan. For example a simple uplift can be applied compared to the pricing plan such that the unit per consumption price is increased uniformly for all users and services. In each case, consumption data 400 is combined with pricing plan 402 and customer hierarchy information 404 to provide a billing scheme 406.

Alternatively different variations may be applied, for example, per cost centre to support an organisations' need to apply charges based on “ability to pay”. For example highly profitable parts of the organisation may pay higher unit rates rather than an “investment phase” division. In that case the secondary pricing plan may be differentiated by cost centre, for example having a higher unit per-consumption price for a given service used at a first cost centre, than for the same service at another cost centre. This can be done, for example, in relation to consumption data to which a secondary pricing plan is applied, by incorporating an additional mapping between the customer hierarchy information and the secondary pricing plan where the secondary pricing plan only provides per-service pricing, or by having a more complex secondary pricing plan provided both on a per-user/cost centre and per service basis.

According to a further alternative it is possible to use the secondary pricing plan to influence demand for services. Where it is desired to discourage the use of services which are intrinsically expensive such as mobile telephony, the charges are uplifted whilst fixed-line charges are billed on at cost or discounted. As a result use of the more expensive services is discouraged whilst encouraging the use of the cheaper services which will result in a lower total spend on telephony. While certain services are encouraged or discouraged, for example the adoption of a new service and obsolescence of a old service, once again differential pricing is implemented in the secondary pricing plan as a result of which the obsolete service becomes increasingly expensive and the new service is subsidised ensuring faster transition to the new service and faster retirement of the old service.

It will be seen that any appropriate combination of the above approaches can be implemented. For example the differential can be applied both between cost centres and between services such that the services are billed differentially but also that different cost centres are billed at different rates. In addition more complex mappings can be implemented for example reallocation of costs between cost centres or services rather than a multiplicatory factor.

It will be appreciated that commercialised forms of the present embodiment would in practice take the form of a set of computer programs adapted to run on general-purpose computing platforms within general-purpose operating environments such as are provided by the Microsoft Windows, Linux or HP-UX operating systems and their related programming libraries and tools. These programs may be marketed in the form of suitably coded computer program products including program code elements that implement the functionality described. It will be appreciated though that the techniques described may equally be implemented as special purpose hardware or any combination of software, hardware and/or firmware.

Referring now to FIG. 5 an apparatus is shown for implementing the method described herein at the service provider. A billing entity such as a processor 500 receives service consumption information 502, a pricing plan 512 and user structure data 514 such as customer hierarchy information or other service user defined criteria to provide primary and secondary billing schemes which are passed to a billing transmission module 508 which allows forwarding of the schemes to the service user 510. It will be appreciated that the various modules and elements can be implemented in software, hardware or firmware and on any appropriate computer platform with appropriate speed and storage capability such that detailed description is not required here. Indeed as existing consumption based billing applications can be re-implemented to obtain the secondary billing scheme any appropriate existing enterprise customer consumption based billing service of this nature can be implemented simply requiring additional processing or memory space as appropriate to obtain a secondary billing scheme. As a result the re-billing service can be provided at a very small incremental cost.

As a result of the arrangement described herein IT operational costs can be controlled and the return on IT investment can be increased with minimal additional costs as existing consumption based billing capability can be implemented, requiring only additional rate plans and multiple executions of the consumption based billing application. Rebilling is made feasible for any organisation which receives services billed by usage.

It will be appreciated that the approach described herein can be adopted in relation to any business or service in which consumption can be tracked and billed and in which an intermediary may require re-pricing of the services either to influence demand or to cover costs.

1. A method of deriving a primary and secondary billing scheme for a plurality of services each having a respective service consumption cost, comprising, at a billing entity, receiving service consumption data, and applying each of a primary and secondary service consumption pricing plan to the service consumption data to derive respective primary and secondary billing schemes.

2. A method as claimed in claim 1 in which the service comprises a computer-related service.

3. A method as claimed in claim 2 in which the computer-related service comprises at least one of computer usage, network usage or computer peripheral usage.

4. A method as claimed in claim 1 in which the service comprises at least one of mobile or land-line telephony.

5. A method as claimed in claim 1 further comprising providing a service user with each of the primary and secondary billing schemes.

6. A method as claimed in claim 1 in which the billings are derived at a service provider.

7. A method as claimed in claim 1 in which the billing entity comprises a common billing processor for both the primary and secondary billing schemes.

8. A method as claimed in claim 1 in which the secondary service consumption pricing plan comprises a variation of the primary service consumption pricing plan.

9. A method as claimed in claim 8 in which the variation differs between services.

10. A method as claimed in claim 8 in which the variation is the same for all services.

11. A method as claimed in claim 8 in which the secondary service consumption pricing plan is derived from primary service consumption pricing plan.

12. A method as claimed in claim 1 in which a service user comprises a plurality of cost centres and the primary and secondary billing schemes bill costs per service per cost centre.

13. A method as claimed in claim 12 in which each cost centre comprises a plurality of cost centre members, further comprising receiving, at the billing entity, a mapping of cost centre members to respective cost centres.

14. A method as claimed in claim 1 in which service consumption data is received from at least one of a consumption monitoring entity within the service provider and a consumption monitoring entity external to the service provider.

15. A computer apparatus for deriving a primary and secondary billing scheme for a plurality of services each having a respective service consumption cost, comprising a billing entity arranged to receive service consumption data and apply each of a primary and secondary service consumption pricing plan to the service consumption data to derive respective primary and secondary billing schemes.

16. A computer readable medium containing instructions arranged to operate a processor to implement the method of claim 1.

17. An apparatus for deriving a primary and secondary billing scheme for a plurality of services comprising a processor configured to operate under instructions contained in a computer readable medium to implement the method of claim 1.
